(19) United States
(12) Patent Application Publication
(10) Pub. No.: US 2026/0031255 A1
(43) Pub. Date: Jan. 29, 2026

(54) Extended Insulator

(71) Applicant: Jock Jawz LLC, Georgetown, IN (US)

(72) Inventors: Nicholas Andrew Hiner, Georgetown, IN (US); Alan Wade Simon, Portland, TN (US)

(73) Assignee: Lock Jawz LLC, Georgetown, IN (US)

(21) Appl. No.: 18/782,963

(22) Filed: Jul. 24, 2024

(51) Int. Cl. H01B 17/14; A01K 3/00

(52) U.S. Cl. CPC H01B 17/145; A01K 3/005

(57) ABSTRACT

An extended insulator assembly holds an electrified wire at a distance from the fence. The assembly does not need to be attached at the fence post but can be attached directly to the fencing. The assembly consists of two arms. At one end, the arms have C-shaped structures featuring a channel into which the electrified wire is inserted. The wire is inserted with the two arms combined such that the grooves are aligned. After the wire is inserted, the arms are rotated locking the wire in place and forming a V-shaped structure that both braces the electrified wire and can be attached to the fence line and firmly holds the wire in place at a distance from the fence line.

### BACKGROUND

Extended insulators are one of the most popular products in the electrified fence industry. Disclosed here is an improved version of these extended insulators.

Most livestock fencing in the world uses more traditional styles: welded wire panel, woven wire, barbed wire, etc. It is well known that animals within these fenced enclosures will, over time, challenge the fence and cause the fencing wire to loosen from the supports, break, and eventually fail. This can be a problem for larger, aggressive animals such as bulls and rams. Even small animals such as pigs can test the fencing with considerable force.

It is also well known that a simple electrified wire can effectively counter these efforts and so farmers add electrified wires, attached to their fencing by way of insulators, to provide additional deterrent.

Experience has shown that the voltage can be set in the harmless range but still provide an adequate deterrent force. This is especially true as the animal will often test the fence with its snout, which is particularly sensitive to even mild electrical shocks.

Shortcomings were seen in these designs as the animals initially challenging the fence can still exert significant force on the fence. To counter this, farmers use extended insulators. While these help somewhat, a problem can still develop. The extended insulators currently on the market primarily attach to the fence posts, whether wooden or T-posts. These hard mounts mean that if an animal challenges the fence and hits one of the insulators, they can and do typically break at the connection to the post. This causes the electric wire to contact the existing fence and short out.

The improved extended insulators maintain the advantage of the current product but have the added advantage of increased strength and no longer need be attached at the fence posts.

### BRIEF DESCRIPTION OF THE DRAWINGS

FIG. 1 is a perspective view of a fence line with an electrified wire which is mounted to the fence using a series extended insulator assemblies.

FIG. 2 is a close up perspective view on a single pair of extended insulator arms mounted on a fence and holding an electrified wire.

FIG. 3A is a side view of a set of extended insulator arms prior to mounting on a fence.

FIG. 3B is a side view of sets of extended insulator arms after mounting on a fence.

FIGS. 4A-B are side views of a set of extended insulator arms.

FIG. 5 is top view of a single extended insulator arm.

FIGS. 6A-B are close ups of the ends of the extended insulator arms that hold the electrified wire.

### DETAILED DESCRIPTION OF THE PREFERRED EMBODIMENTS

The disclosed invention differs from that of the prior art. It doesn't mount to the post but to the existing fence directly. Because of this, the invention does not rely on mounting to just wood posts or t-posts. Thus, the invention will be equally function in a wide variety of fence types completely independent of the type of post used. Thus the invention works with wood posts and t-posts but is not limited to any particular type of post.

Being mounted to the existing fence wire also allows the disclosed insulator a certain “play” or a shock absorber-like property when an animal presses against it. If an animal contacts the electric wire this “play” reduces the chances of breakage even if the animal contacts the wire with some force.

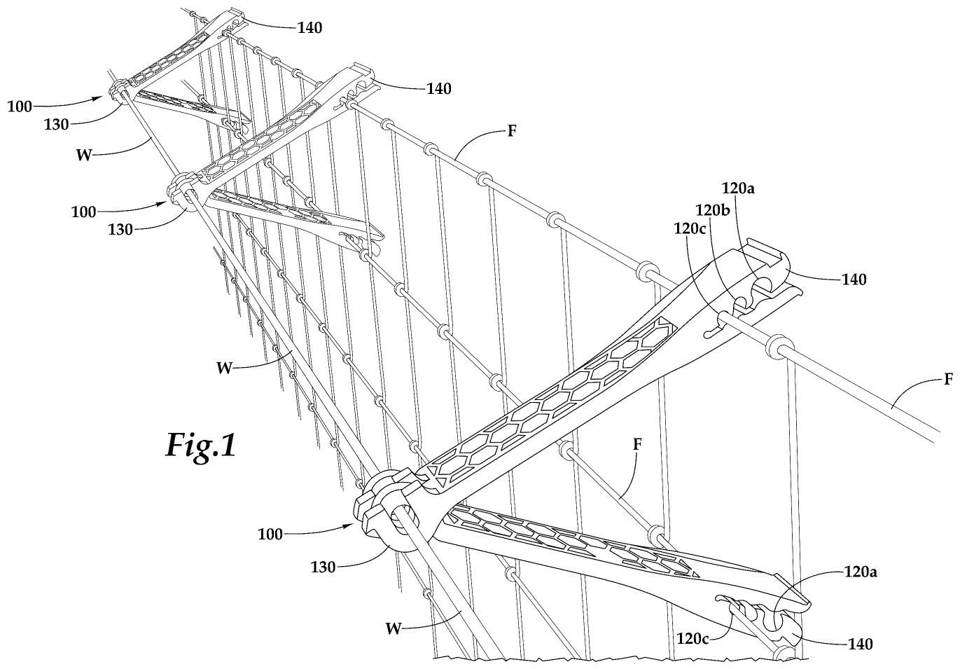

FIG. 1 illustrates a fence line F with the extended insulators 100 holding an electrified wire W. The extended insulators arms have one end 130 designed to hold the electrified wire W and the other end 140 with notches 120a-120c designed to attach to the fence line F.

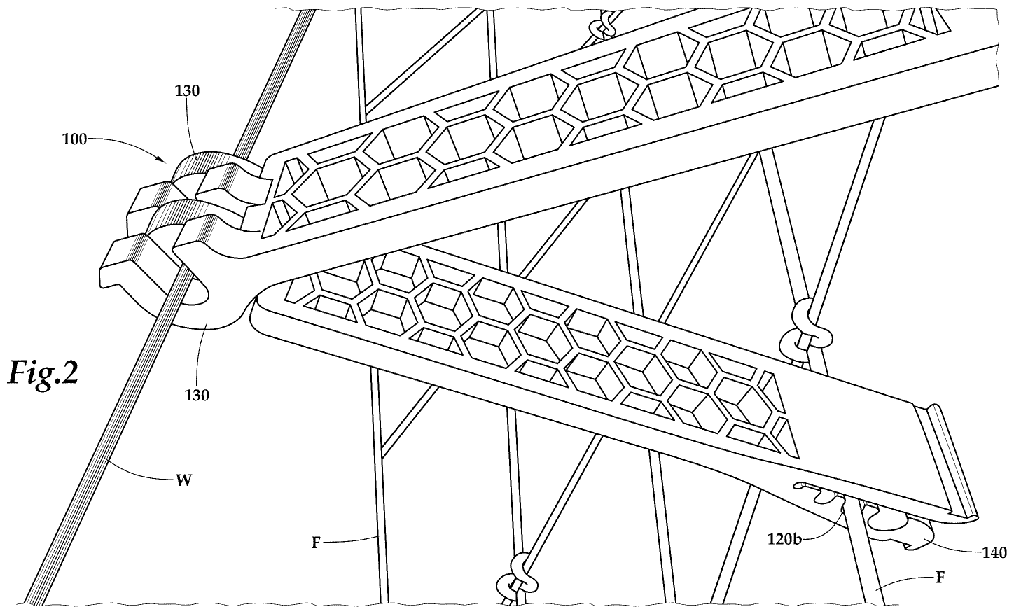

FIG. 2 is a close-up of a single pair of extended insulator arms 100 with one end 140 featuring a notch 120b used to attach the insulator 100 to a fence F with the other end 130 holding an electrified wire W.

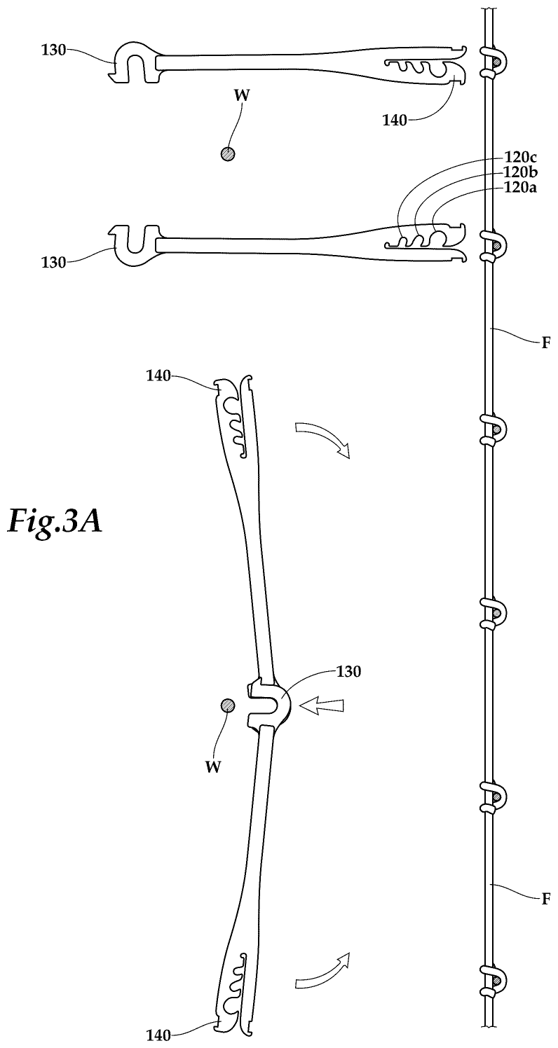

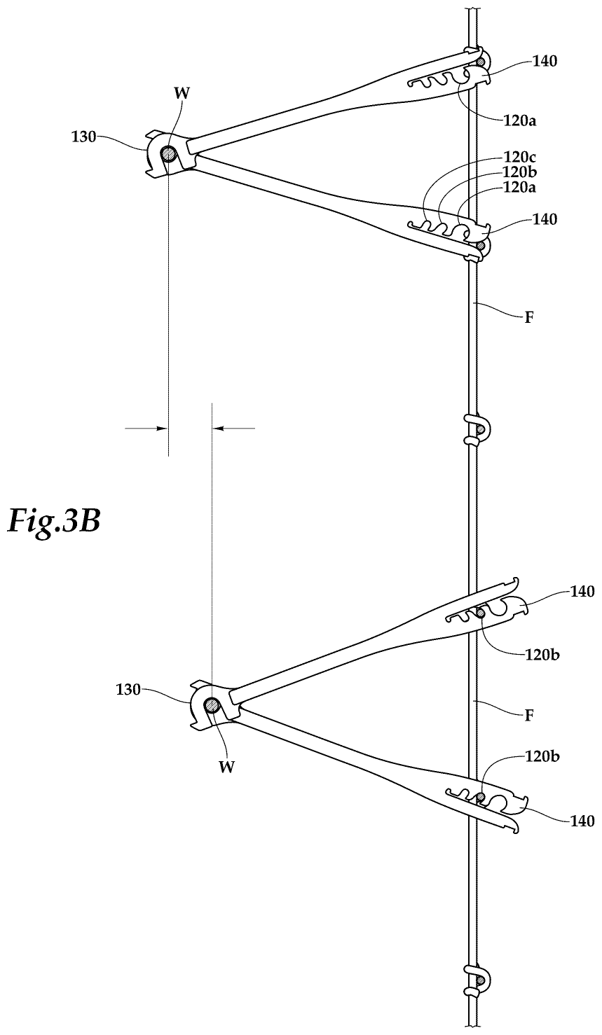

FIG. 3A is a side view of a pair of insulator arms. At the top the insulator arms are shown separated. Note the C-shaped structure at one end 130 and the notches 120a, 120b, 120c cut into the other end 140.

Below the separated insulator arms is an image of the insulator arms with ends 130 aligned and configured in an “open” configuration. In this configuration the electrified wire W can easily be inserted into the slot formed by the C shaped ends.

After the wire is placed in the slot, the two arms are rotated as shown by the two curved arrows in FIG. 3A. The opening in the two C-shapes move out of registry. This closes the opening in the slot, converting it to a circular aperture that completely encloses and traps the electrified wire as shown in FIG. 3B.

In other words, the open ends of the C-shaped structures can pivot away from each other thus closing off the opening and forming a closed portal, or aperture, that holds the electrified wire in place within the closed aperture formed by the interlocking “C” shapes. The electrified wire cannot come out of the insulator without the two arms being decoupled first. Thus, the wire is secured in place.

The two arms 100, now in a V-shaped assembly can each be attached to a fence F. One end 130 of the arms are now locked together holding the electrified wire W. The other ends 140 are attached to a fence using the notches 120a, 120b, 120c. The V-shape now forms a strong structural brace that holds the electrified wire at a distance from the fence. Thus, the animals who come into contact with the wire will not be close enough to the fence to push against the fence and weaken its structural integrity.

Additionally, because the V-shaped assembly is attached, not at the fence post, but at a flexible portion of the fence line, the assembly will have some “give” when the animal pushes against the wire, thus making it less likely that the animal will be able to break the assembly off of the fencing.

Finally, it should be noted that the assembly can be attached to the fence line at multiple heights. Accordingly, if the animals to be fenced in are horses, cows, bulls or the like; the assembly can be mounted in the top region of the fence. If the animals to be fenced in are relatively small, small goats, pigs, etc.; the assembly can be mounted in the bottom region of the fence. Also, the assembly can be attached in the middle region of the fence, for example, to account for a variety of different sized animals.

The user can also “custom” design the height, for example, by measuring the height of the snout of the averaged sized animal to be fenced in.

In another preferred embodiment the ends 140 can have multiple notches of different sizes so as to accommodate fencing of different diameters.

In still another preferred embodiment the notches can be spaced not so much to accommodate different diameters but to allow for the assembly to hold the wire at different distances from the fence. Note in the assembly of FIG. 3B, the electrified wire W is held further from the fence than in the lower assembly.

In a preferred embodiment the two arms of the insulator assembly are identical. In another preferred embodiment the two arms can be manufactured with different structures. Note that the figures illustrate two different versions of the invention which are mirror images. The top two arms in FIG. 3A are the mirror images of the arms in FIG. 1. Also, the arms in FIG. 3B are mirror images of the arms shown in FIG. 1. Either stereo isomer will function in the claimed invention.

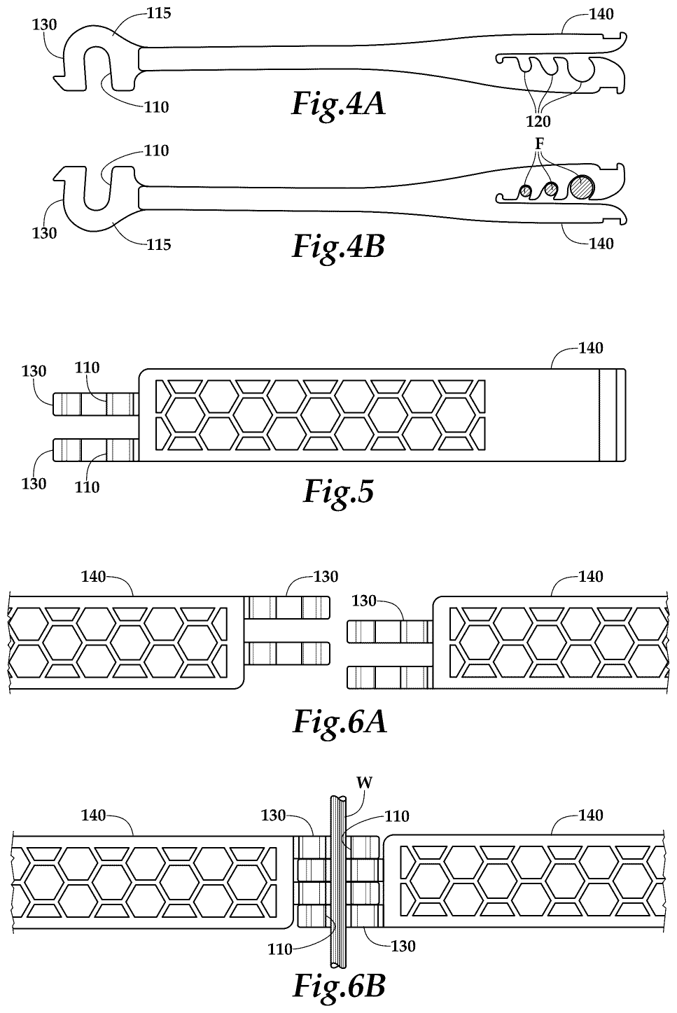

In another preferred embodiment each arm has two C-shaped structures at the end 130 as shown in FIGS. 5, 6A, 6B.

In other preferred embodiments the arms are designed with different shapes. For example, a first arm can have two C-shaped structures and the other can have only one, designed to fit in between the C-shaped structures on the first arm. Alternatively, the other arm can have three C-shaped structures designed to fit in between the C-shaped structures on the first arm and on either side of the first arm.

When the arms have identical structures, the notches that hold the arms to the fence are either on the inner side of the V-shaped structure, as shown in FIG. 3B, or the outer side of the structure. Either of these configurations is acceptable

In a preferred embodiment the C-shaped structures are held together in the final assembly by the electrified wire passing through the aperture formed by the C-shapes. This is shown in detail in FIGS. 4-6. The ends 130 of the two arms are brought together such that the C-shaped structures mutually interdigitate as shown in the transition from FIG. 6A to FIG. 6B. FIG. 6B shows the two arms together in the “open” configuration. When in this open configuration the electrified wire is inserted into the groove 110 in the C-shaped structure 115. The two arms are then rotated into the “closed” configuration and installed on the fence as described above.

As stated above, when the arms are in the “closed” configuration, the electrified wire holds the ends 130 together. In another preferred embodiment, the C-shaped structures can have surface features in place that hold the assembly together, such as complementary semicircular grooves and ridges on the sides of the C-shaped structures.

Recall that prior art extended insulators are bar shaped and have only a single point of contact with the existing fence. Compared with the prior art, the disclosed insulators have a much more stable and strong structure. The disclosed insulator will reliably hold the electrified wire a safe distance from the non-electrified existing fence.

What is claimed is:

1) An extended insulator assembly, a plurality of which are useful for holding an electrified wire away from a fence, comprising:
a first arm and a second arm,
the first arm having one end configured to attach to the fence and the other end comprising one or more generally C-shaped structures,
the second arm having one end configured to attach to the fence and the other end comprising one or more generally C-shaped structures,
the first and second arm generally C-shaped structures configured to pivotably engage such that the arms can pivot from an open configuration to a closed configuration,
wherein in said open configuration the C-shape open ends are aligned to form a groove into which an electrified wire can be inserted,
wherein when pivoted from said open to said closed configuration the arms form a generally V-shape and the C-shape open ends no longer align such that the two C-shaped ends form a closed aperture that will enclose the inserted electrified wire, and
wherein in said closed configuration the extended insulator arms' first ends are attached to the fence, the V-shape allowing a plurality of assemblies, when linearly arrayed along the fence, to brace the electrified wire away from the fence line.

2) The extended insulator assembly as defined in claim 1, wherein the first and second arms generally C-shaped ends further comprise two C-shaped structures spaced apart so that when these ends are pivotably engaged the C-shaped structures mutually interdigitate forming an aperture is made up of C-shaped ends from alternating arms.

3) The extended insulator assembly as defined in claim 2 wherein the aperture made up of the alternating C-shaped ends is held together by the electrified wire trapped within the aperture.

4) The extended insulator assembly as defined in claim 1, wherein the ends configured to attach to the fence further comprise one or more notches designed to form a firm friction fit with the fence.

5) The extended insulator assembly as defined in claim 4, wherein the one or more notches further comprise notches of different sizes to form friction fits with fencing of different diameters.

6) The extended insulator assembly as defined in claim 5 wherein the one or more notches are designed to form friction fits with fencing selected from the group consisting of: welded wire panel, woven wire, chain link, barbed wire.

7) A method of electrifying a fence comprising the use of an extended insulator assembly said assembly comprising:
a first arm and a second arm,
the first arm having one end configured to attach to the fence and the other end comprising one or more generally C-shaped structures,
the second arm having one end configured to attach to the fence and the other end comprising one or more generally C-shaped structures,
the first and second arm generally C-shaped structures configured to pivotably engage such that the arms can pivot from an open configuration to a closed configuration,
wherein in said open configuration the C-shape open ends are aligned to form a groove into which an electrified wire can be inserted,
wherein when pivoted from said open to said closed configuration the arms form a generally V-shape and the C-shape open ends no longer align such that the two C-shaped ends form a closed aperture that will enclose the inserted electrified wire, and
wherein said method comprises the following steps:
the ends of the assembly are placed in open configuration,
an electrified wire is inserted into the groove,
the ends are pivoted from said open to said closed configuration,
the arms' first ends are attached to the fence, and
the processes is repeated one or more times such that a plurality of assemblies are linearly arrayed along the fence and brace the electrified wire away from the fence line and thus electrify the fence.

8) A method of electrifying a fence as defined in claim 7, wherein the linear array is placed in the bottom region of the fence line.

9) A method of electrifying a fence as defined in claim 7, wherein the linear array is placed in the top region of the fence line.

10) A method of electrifying a fence as defined in claim 7, wherein the linear array is placed in the middle region of the fence line.

11) A method of electrifying a fence as defined in claim 7, wherein the linear array is placed at about snout height of the average sized animal in the fenced in area.
